(19) United States
(12) Patent Application Publication
(10) Pub. No.: US 2006/0287891 A1
(43) Pub. Date: Dec. 21, 2006

(54) System and method in a computerized environment for charting pediatric growth

(75) Inventors: Kay L. Grasso, Kansas City, MO (US); Arpi Chalian, Summit, NJ (US); Thomas C. Gifford, Kansas City, MO (US); Ronda L. Sharp, Overland Park, KS (US)

Correspondence Address: SHOOK, HARDY & BACON L.L.P.;Intellectual Property Department, 2555 GRAND BOULEVARD, KANSAS CITY, MO, 64108-2613, US

(73) Assignee: Cerner Innovation, Inc., Overland Park, KS (US)

(21) Appl. No.: 11/154,154

(22) Filed: Jun. 16, 2005

(51) Int. Cl. G06F 19/00; G09G 5/00

(52) U.S. Cl. 705/3; 345/619

(57) ABSTRACT

A method for displaying patient growth data on a computerized growth chart is provided. A database including growth chart data for a computerized growth chart appropriate for a patient is accessed and the growth chart data is utilized to display the computerized growth chart. The patient's electronic record is accessed for patient growth data and the patient growth data is displayed on the computerized growth chart.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

A growth chart is used to track pediatric measurements such as height, weight, length and head circumference, to see how a child measures in relation to other children his/her age or with similar diagnoses. A growth chart includes percentile curves of children's measurements and a patient's measurements are plotted in relation to the percentile curves. Types of growth charts include the Center for Disease Control (CDC) growth charts, specialty growth charts such as Down's Syndrome, Turner Syndrome, Babson and Nallhaus growth charts and other growth charts specific to countries or regions.

Oftentimes, pediatric growth is charted on a paper medical record. In the paper medical record, the practitioner caring for patients with growth problems has the capability of making special notations directly on the growth chart as they track growth and trends. However, the paper medical records are not compatible with the trend toward storing patient information in a computerized environment, such as an electronic medical record.

Current electronic medical records and hand held devices with electronic growth chart capabilities, do not allow access to a patient's electronic medical record when plotting patient data on a growth chart nor do they allow for notations to be added directly to the electronic growth chart. Furthermore, these electronic growth charts do not allow the patient growth data to be filtered according to a user's preferences. Furthermore, these growth charts only display one growth chart, e.g. length, at one time. These charts do not have the capability to display more than one growth chart side by such, e.g. length and weight, at one time. These electronic growth charts also do not allow for a patient's growth chart to be displayed at the same time a measurement table for the patient is displayed.

It would be beneficial to have a computerized growth chart with the capability of accessing a patient's electronic medical record to obtain patient growth data such as measurements and event annotations. It would also be beneficial to be able to filter the view of the computerized growth chart to display only the patient growth data that is of interest to a user. It would also be beneficial to have an interactive user interface that displays more than one growth chart for a patient and an interactive user interface that displays a growth chart for a patient alongside a growth measurement table for the patient.

### SUMMARY OF THE INVENTION

In one aspect, the present invention relates to a method for displaying patient growth data on a computerized growth chart. The method comprises accessing a database including growth chart data for a computerized growth chart appropriate for a patient and utilizing the growth chart data to display the computerized growth chart. The method further comprises accessing the patient's electronic record for patient growth data and displaying patient growth data on the computerized growth chart.

In another embodiment, the present invention relates to a method for displaying patient growth data on one or more computerized growth charts. The method comprises accessing a database including growth chart data for a computerized growth chart appropriate for a patient and utilizing the growth chart data to display at least one computerized growth chart. The method further includes accessing the patient's electronic record for patient growth data. A selection of patient growth data to display is received and the requested patient growth data on the at least one computerized growth chart is displayed.

In another embodiment, the present invention relates to a user interface embodied on at least one computer readable medium, the user interface is for representing data to a user is provided. The user interface comprises a growth chart image display area configured to display at least one growth chart for a patient and a growth measurement table display area configured to display a growth measurement table for the patient.

In yet another embodiment, a user interface embodied on at least one computer readable medium, the user interface is for representing data to a user. The user interface comprises a first growth chart display area configured to display a first growth chart for a patient and a second growth chart display area configured to display a second growth chart for a patient, the second growth chart being different from the first growth chart.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a block diagram of an exemplary system for use in implementing embodiments of the present invention;

FIG. 3 is a flow diagram of a method for plotting a growth chart and displaying patient growth data in accordance with an embodiment of the present invention;

FIG. 4 is a flow diagram of a method for displaying a pediatric growth chart and patient growth data according to requests received in accordance with an embodiment of the present invention;

FIG. 5 is a flow diagram of a method for receiving patient growth data to be documented on a pediatric growth chart in accordance with an embodiment of the present invention;

FIG. 6 is an exemplary interactive display list of patients in accordance with an embodiment of the present invention;

FIG. 7 is an exemplary interactive side by side display of a length for age growth chart and weight for age growth chart in accordance with an embodiment of the present invention;

FIG. 8 is an exemplary interactive display of a change view screen for changing the view of a growth chart in accordance with an embodiment of the present invention;

FIG. 9 is an exemplary interactive side by side display of growth charts and drop down menu for inputting patient growth data in accordance with an embodiment of the present invention;

FIG. 10 is an exemplary interactive display for inputting patient growth data in accordance with an embodiment of the present invention;

FIG. 11 is an exemplary interactive display for inputting patient growth data in accordance with an embodiment of the present invention;

FIG. 12 is an exemplary interactive display for inputting event information related to a growth chart in accordance with an embodiment of the present invention;

FIG. 13 is an exemplary interactive table display of patient growth data to be added to a growth chart in accordance with an embodiment of the present invention;

FIG. 14 is an exemplary interactive display of a growth chart and table of patient growth data in accordance with an embodiment of the present invention;

FIG. 15 is an exemplary interactive side by side display of a length for age growth chart and weight for age growth chart with bone age and mid-parental height plotted in accordance with an embodiment of the present invention; and

FIG. 16 is an interactive table display of patient growth data according to age to be plotted on a growth chart in accordance with an embodiment of the present invention.

### DETAILED DESCRIPTION OF THE INVENTION

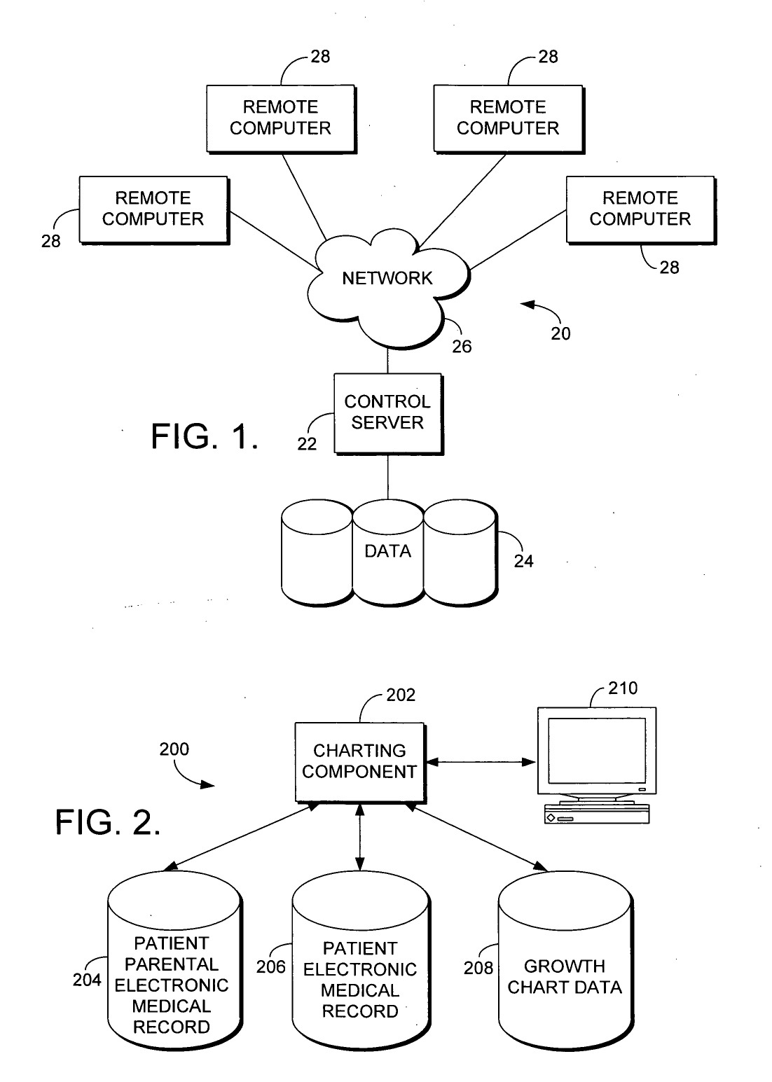

With reference to FIG. 1, an exemplary medical information system for implementing the invention includes a general purpose-computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians include, but are not limited to, the treating physician, specialists such as surgeons, radiologists and cardiologists, emergency medical technologists, physician's assistants, nurse practitioners, nurses, nurse's aides, pharmacists, dieticians, microbiologists, laboratory experts, genetic counselors, researchers, veterinarians and the like. The remote computers may also be physically located in non-traditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

Although the method and system are described as being implemented in a WINDOWS operating system operating in conjunction with an Internet-based system, one skilled in the art would recognize that the method and system can be implemented in any system.

Referring next to FIG. 2, a block diagram of an exemplary system for use in implementing embodiments of the present invention is shown. The system 200 comprises a charting component 202 which is in communication with databases 204, 206, and 208. Charting component 202 may be in communication with or located on a remote computer 210 to be used by a user. Charting component 202 accesses chart database 208 to obtain chart definitions, reference curves, statistical information and historical records for growth charts.

Chart definitions include unique characteristics of a type of growth chart such as length, weight, height and head circumference. The chart definitions include the age ranges and genders of patients for which the chart applies, as well as the source of the chart and actual physical characteristics of the chart. The reference curves are a series of points identified with a particular data set. For example, a curve representing the third percentile in a growth chart may be stored as several X and Y value pairs. The charting component 202 plots the X and Y value on the growth chart and connects them to create a reference curve. The reference curves are drawn on a growth chart by plotting each of the data points and connecting them with a smooth curve. The resulting growth chart and curves may be displayed on a computer screen or printed. Statistical information for each type of growth chart for several age ranges is also stored in database 208. Historical records include previous chart definitions, references curves, and statistical information for growth charts that have changed.

Database 206 includes patient data stored in the form of an electronic medical record for the patient. An electronic medical record for a patient include patient growth data such as the patient's age, gender, weight, length, measurement, date recorded, recorded problems or diagnoses, head circumference, growth measurements, bone age, event annotations, mid-parental height information, body mass index and a variety of other patient data. Database 204 is the electronic medical record of a patient's parents and may contain data such as height and weight of the parent along with a variety of other patient data. The charting component 202 plots the patient growth data on an appropriate growth chart.

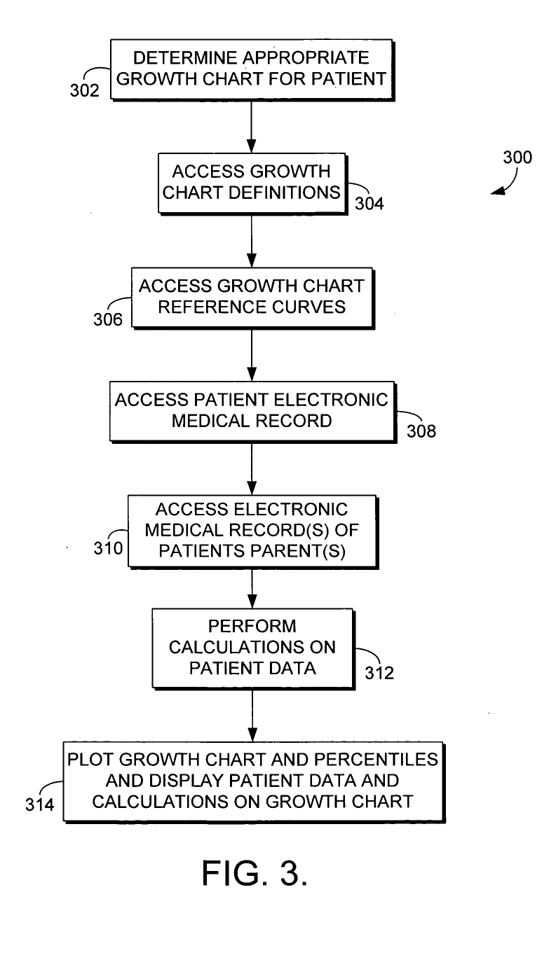

With reference to FIG. 3, a method 300 for plotting a growth chart and displaying patient data and calculations on the growth chart is shown. At step 302, the appropriate growth chart to be displayed for the patient is determined. The growth chart most appropriate based on age, gender, method of measurement and recorded problems or diagnosis may be automatically displayed at step 302. Alternatively, a user may request that a particular type of growth chart be displayed for the patient. Types of growth charts include, but are not limited to, the Center for Disease Control (CDC), growth charts for length, weight, head circumference, height, body mass index, weight for length, and weight for height, Down Syndrome growth chart for height and weight, Turner Syndrome growth chart for height, Babson growth chart for length, weight, head circumference, Nallhaus growth chart for head circumference and various pre-maturity growth charts. Furthermore, different growth charts may also be available throughout the world and may be specific to other countries and areas.

At step 304, growth chart data is accessed from a database. Growth chart data includes chart definitions such as the type of chart (length, weight, head circumference, height, weight for length and weight for height and body mass index), age range and gender of patients for which the chart applies, as well as the source of the chart, and actual physical characteristics of the chart. This information is used when creating the display of the appropriate growth chart for the patient.

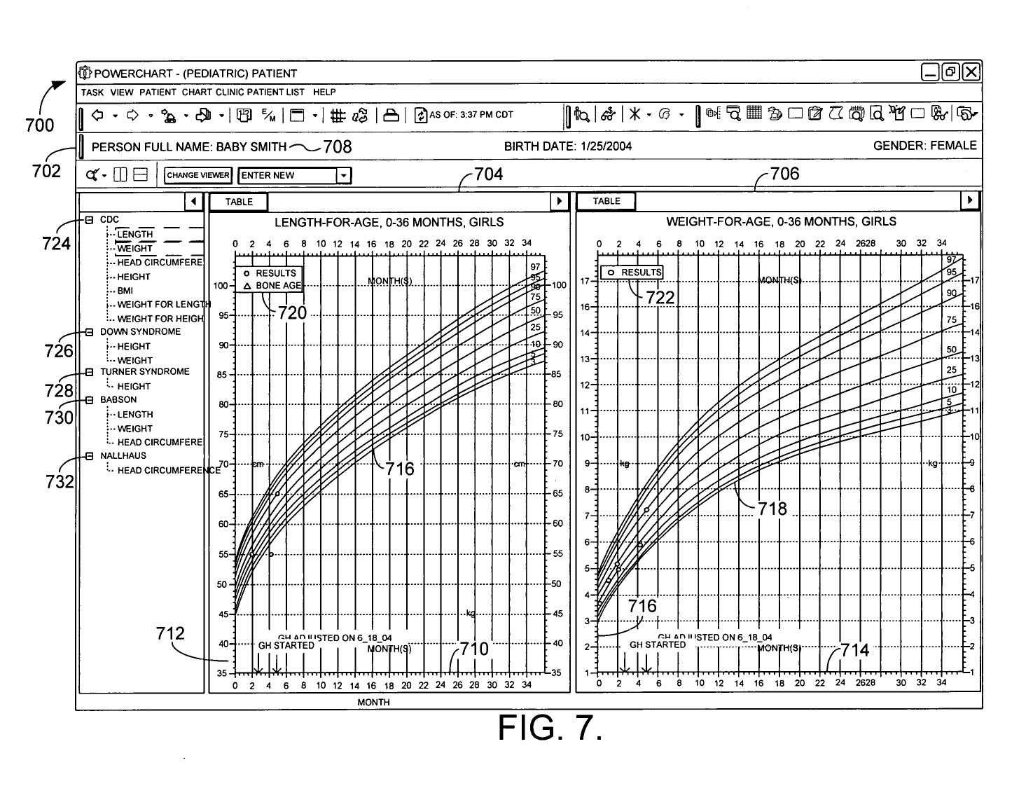

At step 306, growth chart reference curves are accessed from a database. The reference curves are a series of points identified with a particular data set. For example, a curve representing the third percentile for weight for a particular age range may be stored as several XY value pairs. The reference curve is drawn by plotting each of the data points for the XY value pairs and connecting them with a smooth curve. Exemplary reference curves are shown in FIGS. 7, 9, 14, and 15.

At step 308, the patient's electronic medical record is accessed. The patient's electronic medical record includes growth data entered for the patient. This data can include height and weight measurements, length measurements, the date the measurements were taken, head circumference measurements, body mass index, weight for length, weight for height, bone age, event annotations, gender of the patient, and any other information that has been documented for the patient along with when and by whom the documentations were made. Event annotations include any events occurring in the patient's life including starting school, beginning human growth hormone and other medical treatments relevant to the patient's growth chart. In one embodiment, the events are identified in the patient electronic medical record as annotations.

Optionally, at step 310, the electronic medical records of a patient's parents are accessed. Again, patient data is stored in these records and the parental height can be accessed and used to determine the mid-parental height for one or more of the patient's parents and displayed on the growth chart. In another embodiment, the mid-parental height is entered into the system and documented in the patient's electronic medical record. Thus, when the patient's medical record is accessed, the mid-parental height is obtained and displayed on the computerized growth chart. In yet another embodiment, mid-parental height is not displayed on the computerized growth chart.

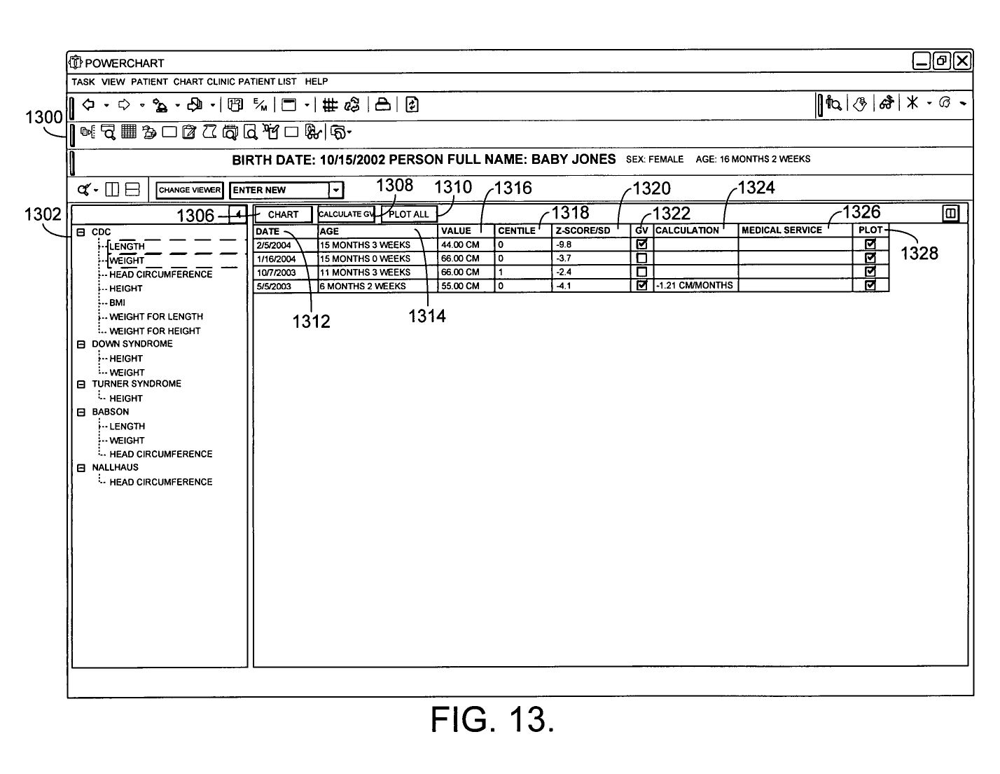

At step 312, calculations are performed on the patient data based on the appropriate growth chart that will be displayed for the patient. These calculations include using growth chart data accessed from the patient's electronic medical record to determine the percentile to which the patient falls within the appropriate growth chart and z-score calculations for the growth chart measurements using the reference data provided for the growth charts. The statistical reference information is compared to the patient data. The patient's age is compared to the available and age ranges for the particular growth chart. When the appropriate age range is determined, the patient's percentile and Z-score are calculated from given reference statistics and the recorded patient data from the patient's electronic medical record. Growth velocity calculations may also be performed using at least two patient measurements taken on different dates. For example, with reference to FIG. 13, a table view 1300 of patient measurements 1314 is shown. In the exemplary table 1300, two patient measurements have been selected to have the growth velocity 1322 calculation performed. Thus, in this example, the growth velocity would be calculated between the measurements for the patient taken on May 5, 2003 and Feb. 5, 2004.

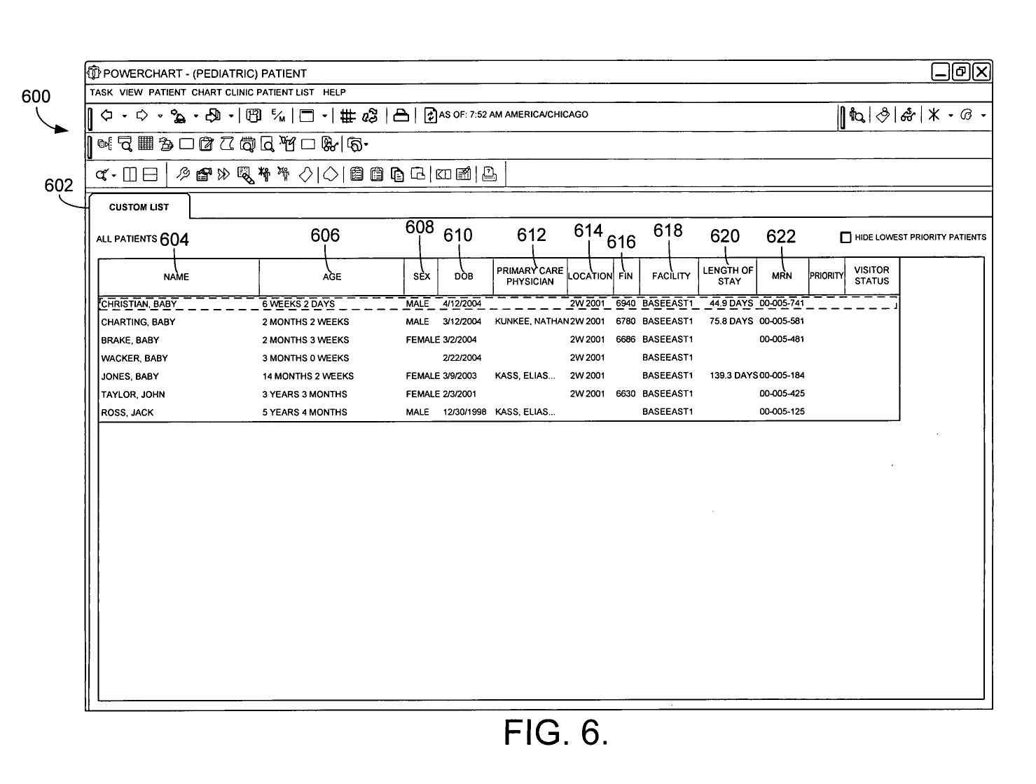

Referring again to FIG, 3, at step 314, the appropriate growth chart is displayed, the reference curve is plotted using growth chart reference data and patient data and calculations are displayed on the growth chart. By way of example, and not be limitation, with reference to FIG. 6, an exemplary interactive display 600 of a list of patients is displayed. The list 602 of patients includes information regarding the patients such as name 604, age 606, sex 608, data of birth, 610, primary car physician 612, location 614, FIN 616, facility 618, length of stay 620, and MRN 622. The user can select the appropriate patient from the patient list to display a growth chart.

An exemplary interactive user interface growth chart 700, such as the one shown in FIG. 7, is displayed. The exemplary user interface growth chart 700 includes the patient's name 702, a navigation bar 724 and two growth charts 704 and 706. The exemplary navigation bar lists possible types of growth charts for patients such as the CDC growth charts 724, Down Syndrome growth charts 726, Turner Syndrome growth chart 728, Babson growth charts 730 and Nallhaus growth chart 732.

The growth chart in FIG. 7 is for fictitious patient Baby Smith 708 is a female infant younger than 36 months. Thus, the appropriate growth chart for Baby Smith is the CDC's length-for-age growth chart 704 for 0-36 month old girls. As discussed above, the reference curves are drawn by plotting data points for the CDC's length-for age growth chart for 0-36 month old girls and connecting them with a smooth curve. In FIG. 7 reference percentile curves 716 for length-for age 0-36 month old girls are displayed for the 97^{th}, 95^{th}, 90^{th}, 75^{th}, 50^{th}, 25^{th}, 10^{th}, 5^{th} and 3^{rd} percentiles.

The patient measurements (results 720) are displayed on the computerized growth chart that plots the length of the patient 712 in centimeters (cm) based on the age 710 (in months) of the patient when the measurement was taken. For example, with reference to FIG. 7, patient measurements are displayed on the computerized growth chart. For example, fictitious patient Baby Smith's length measurements were taken when the patient was two months, four months and four and one half months old. Baby Smith was 55 centimeters at two months old, 55 centimeters at four months old and 65 old centimeters at four and one half months old. At two months old, Baby Smith was in the 25^{th} percentile for length-for-age relative to other children her age and gender. However, at four months old, Baby Smith had fallen below the 3^{rd} percentile for length-for-age relative to other children her age and gender. When Baby Smith was measured at four and one half months, Baby Smith was in the 50^{th} percentile for length-for-age relative to other children her age and gender.

Furthermore, in FIG. 7, other growth data for the patient may also be displayed on the computerized growth chart. For example, growth data for the patient, such as event annotations in Baby Smith's electronic medical record, are also displayed. Baby Smith was started on human growth hormone at two and one half months old and the growth hormone was adjusted when Baby Smith was a little over four months old. The event annotations are displayed along the horizontal axis 710 of the length-for-age growth chart of FIG. 7 displaying the patient's age in months.

FIG. 7 also includes a second growth chart 706 for weight-for-age for girls 0-36 months. The patient measurements (results 722) are displayed on the computerized growth chart that plots the weight 716 of the patient in kilograms (kg) based on the age 714 (in months) of the patient when the measurement was taken. Reference percentile curves 718 for weight-for age 0-36 month old girls are displayed for the 97^{th}, 95^{th}, 90^{th}, 75^{th}, 50^{th}, 25^{th}, 10^{th}, 5^{th} and 3^{rd} percentiles.

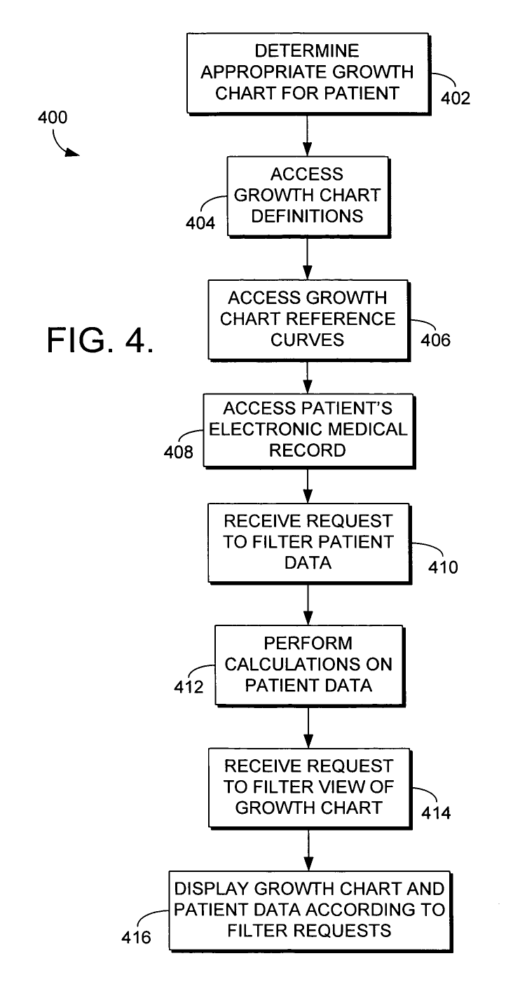

With reference next to FIG. 4, a method 400 for displaying a pediatric growth chart and patient data according to requests received is shown. At step 402, the appropriate growth chart for the patient is determined based on patient age or diagnosis. At step 404, growth chart definitions for the patient are accessed. At step 406, the growth chart reference curves for the appropriate growth chart for the patient are accessed. At step 408, the patient's electronic medical record is accessed for patient growth data such as, growth chart measurements for the patient. At step 410, a request to filter the patient data is received. For example, the patient data may be filtered by only displaying measurements taken at well-baby visits and not using measurements during hospital admissions which include daily weights. Alternatively, the patient data may be filtered by the provider or department that took the patient measurement.

For example, in FIG. 13 a table view 1300 of patient measurements 1314 is shown. The table view includes a navigation bar 1302 and growth data for a patient. The growth data includes the date 1312 a measurement was taken, age 1314 of the patient when the measurement was taken, value 1316 of the measurement, percentile 1318 of the measurement, z-score/standard deviation 1320, growth velocity calculations 1324, medical service performing 1326 measurement and options 1322 and 1328 for selecting measurements to be used to calculate growth velocity and whether to plot the measurement on the growth chart respectively. Table view 1300 also includes options that may be selected by the user including a chart options 1312 to chart the growth data from the table view on the appropriate growth chart, a calculate growth velocity option 1308 to calculate the growth velocity and plot all option 1310 to plot all measurements in the table view onto the appropriate growth chart for the patient.

In this view, all measurements have been selected to be plotted 1328. However, a user from one department, such as the cardiac department, could select to plot only measurements taken from a certain medical service 1326 (e.g. the cardiac department) while a user from a second department, such as pediatrics, may only want to view measurements taken during visits to the patient's pediatrician. The user would select to plot only those measurements in FIG. 13 his or her department. Only the data received in the request will be kept to perform any calculations on the patient data and be displayed on the growth chart.

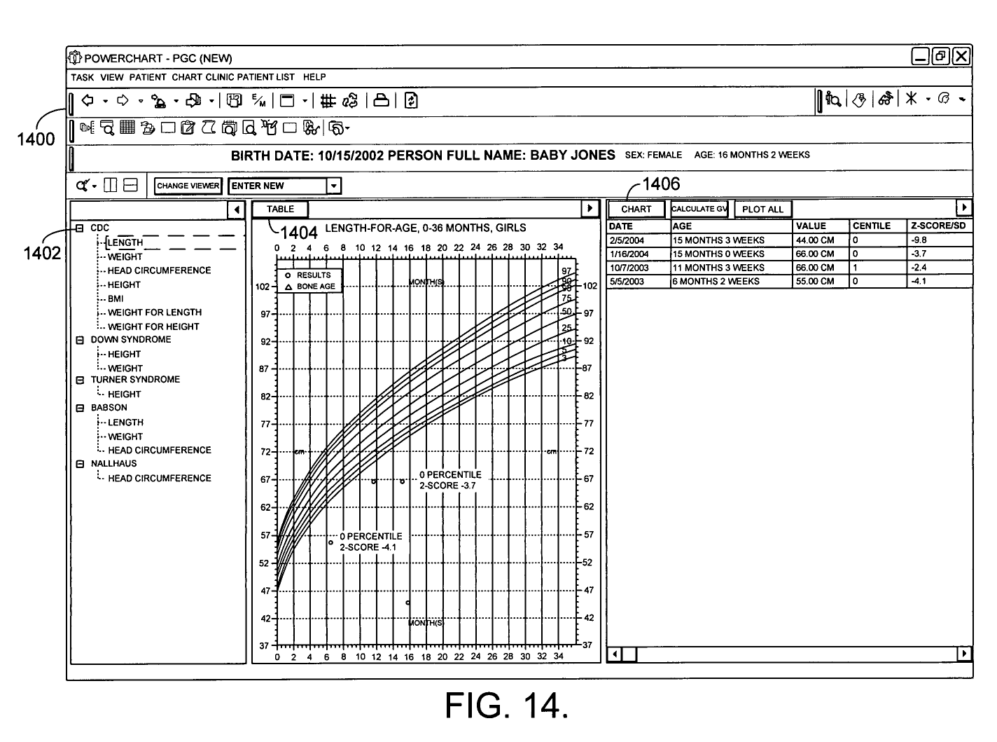

Referring again to FIG. 4, at step 412, calculations on the filtered patient data are performed. For example, calculations such as percentile, Z-scores, and growth velocity as described above may be performed on patient growth data selected to be charted. At step 414, a request to filter the view of the growth chart is received. For example, a user may want to view a side-by-side view length growth chart and weight growth chart as shown in FIG. 7. Alternatively a user may wish to view the length growth chart next to the head circumference growth chart. Another view would be to display one plotted growth chart, such as length or weight along with the corresponding elements in a table view as shown in FIG. 14.

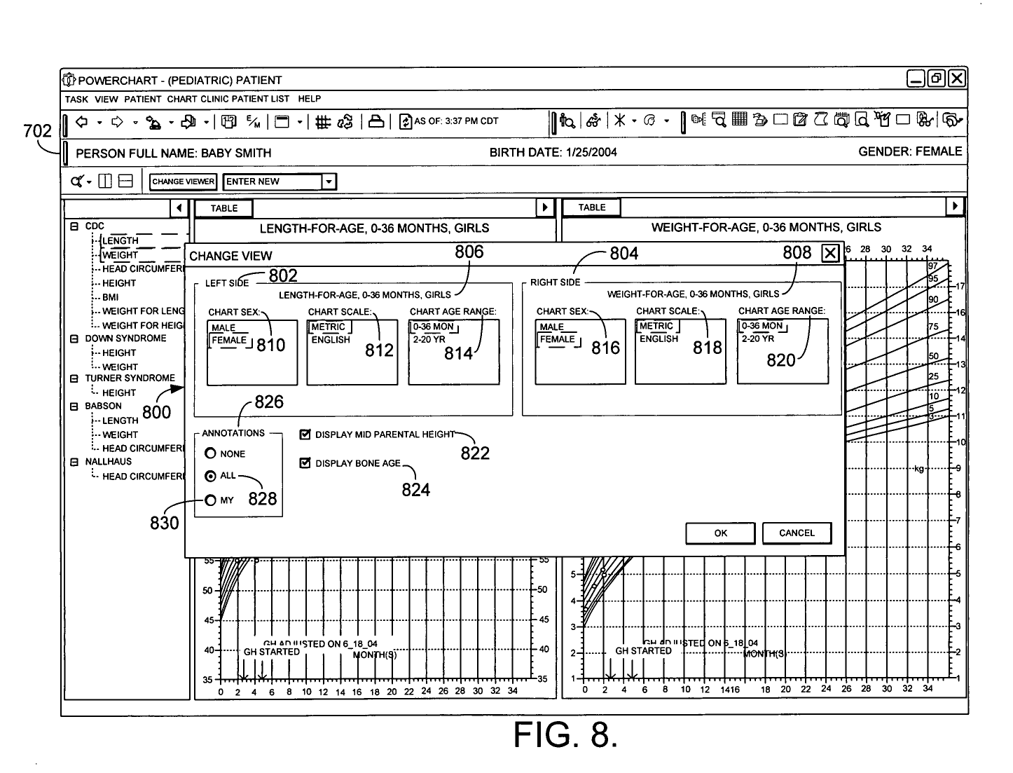

Other ways the view of the growth chart may be filtered include whether annotations, mid-parental height and bone age should be displayed, the gender and age range for the chart and the system of measurement used to display the chart. With reference to FIG. 8, an exemplary interactive user interface 800 for filtering a growth chart view is shown. In the exemplary user interface 800, the left side 802 and right side 804 can be filtered or modified. For example, the left side of the exemplary growth chart in FIG. 8 is a length-for-age growth chart 806 for 0-36 month girls. A user can select what sex 810 to display, the scale 812 that the chart should be displayed and the age range 814 for the chart. The right side of the exemplary growth chart is a weight-for-age growth chart 808 for 0-36 month girls. Again, a user can select what sex 816 to display, the scale 818 and the age range 820 for the growth chart. A user may also select what type of annotations 826 to display. For instance, a user may choose to view no annotations, all annotations 828 or only annotations made by the user 830. In this example, a user has selected to view all annotations 828. The user may also select whether or not to display mid-parental-height 822 and bone age 824.

Referring again to FIG. 4, at step 416, the appropriate growth chart for the patient and patient growth data and calculations are displayed according to filtered requests. For example, if a user requested only to view measurements from well-baby visits and in a side-by-side view of length and height. The growth chart displayed would be a side-by-side growth chart, one for length and for height, with only measurements taken a well-baby exam plotted on each side of the growth chart.

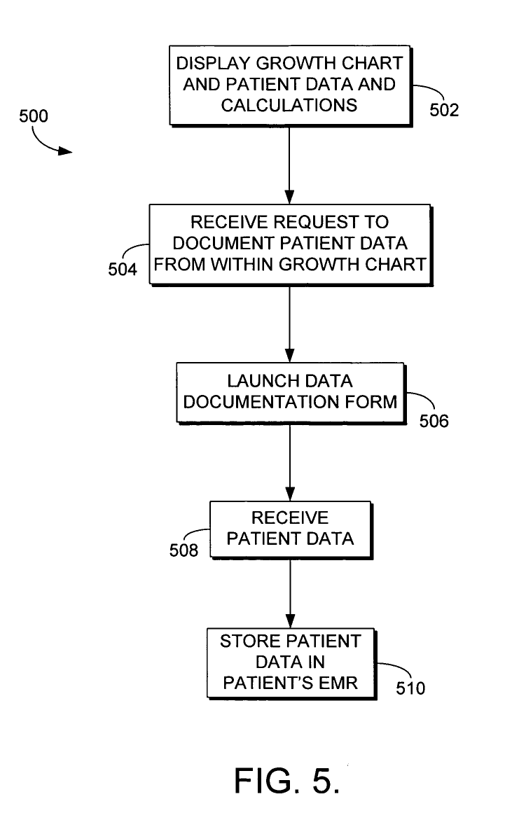

With reference to FIG. 5, a method for receiving patient growth data to be documented for a patient from a pediatric growth chart is shown. At step 502, the appropriate growth chart, and patient growth data and calculations are displayed. At step 504, a request to document patient growth data from within the growth chart is received. At step 506, a data documentation form is launched for the entry for the patient data information. The patient data information may include height, length, weight and head circumference measurements along with event annotations, bone age measurements, and mid-parental height measurements.

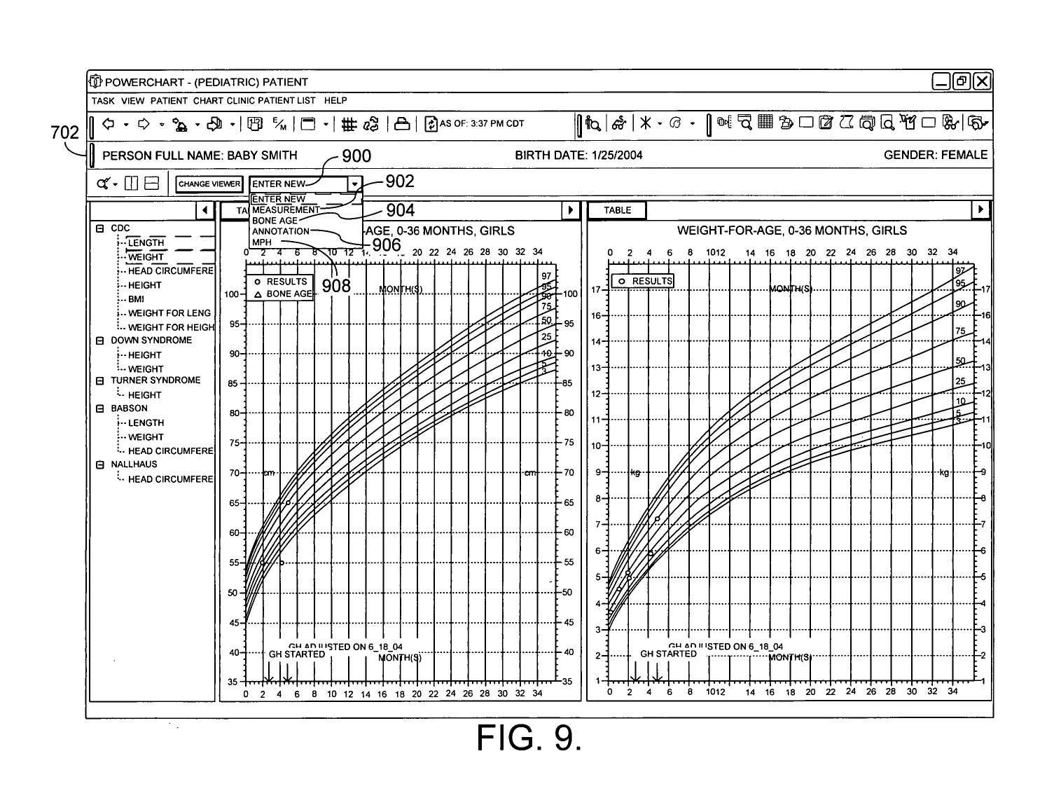

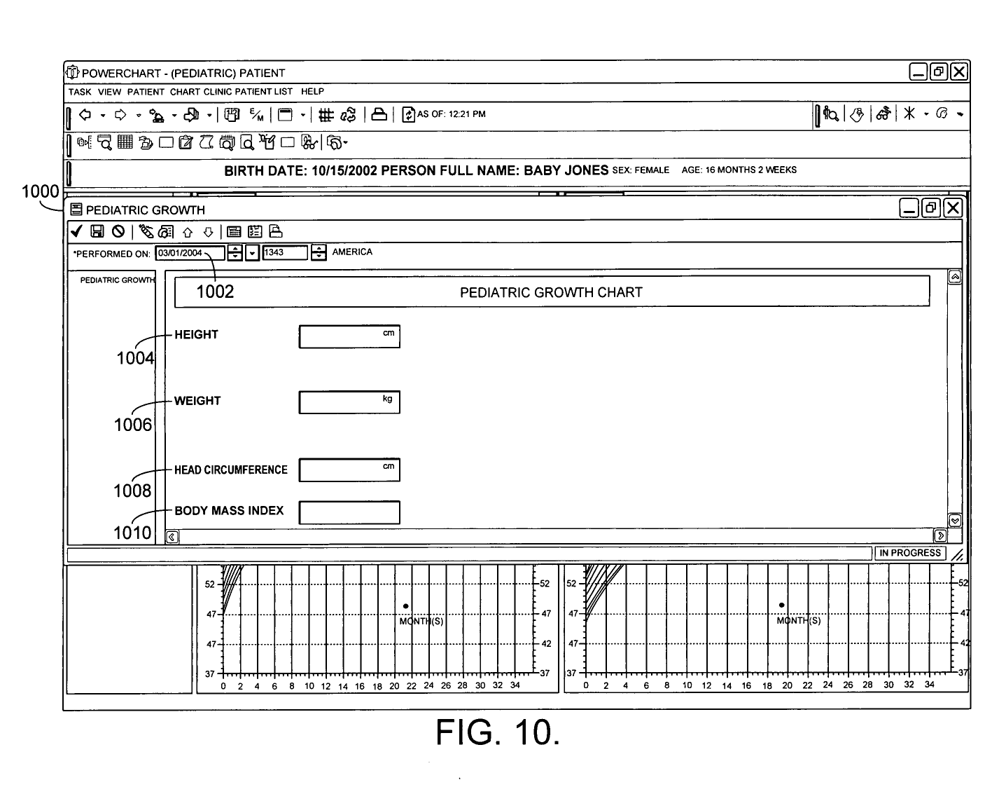

With reference to FIG. 9, a user may select to enter a new measurement 902, enter bone age 904, enter event annotation 906 or enter mid parental height 908 from the drop down menu 900 of the interactive user interface 702 to document patient growth data from within the growth chart. If the user selects to enter new measurements 904, a data documentation form 1000, such as the exemplary form shown in FIG. 10, is opened. A user can enter new measurements, such as height 1004, weight 1006, head circumference 1008 and body mass index 1010, and the date 1002 the measurements were performed for the patient into the data documentation form 1000. After receiving the patient growth data, the data is stored for the patient. In one embodiment, the patient growth data is stored in the patient's electronic medical record.

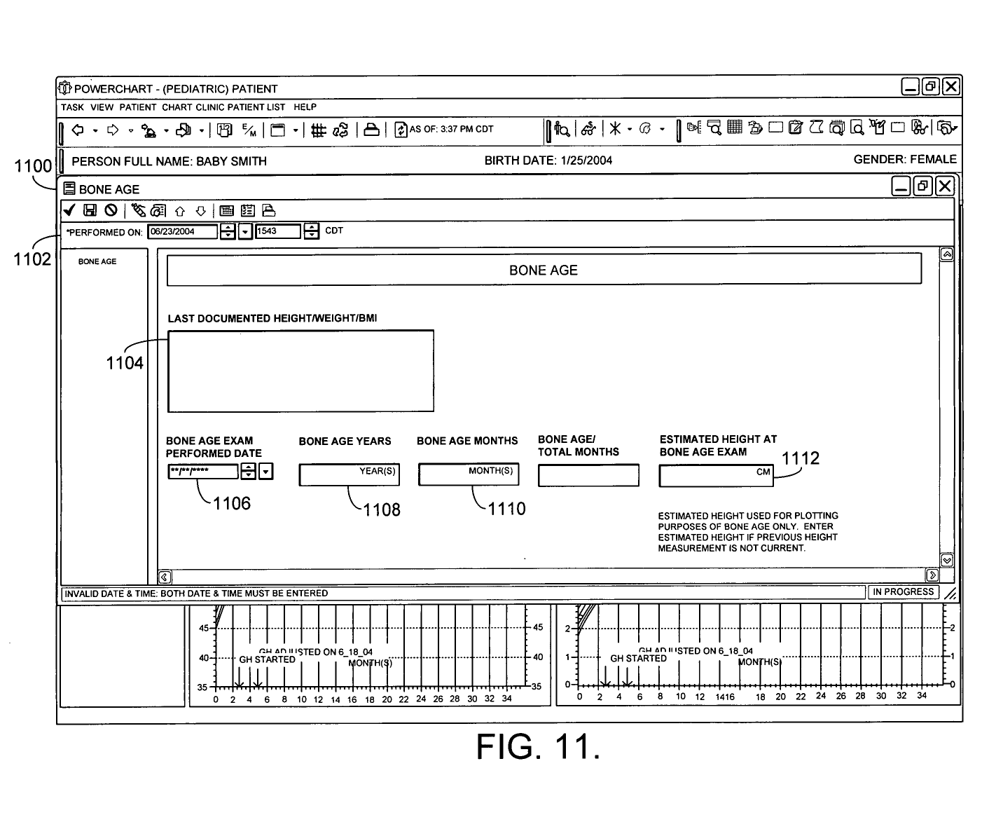

If the user selects to enter bone age 904 from FIG. 9, a data documentation form 1100, such as the exemplary documentation form shown in FIG. 11, is opened. From the data documentation form 1100 a user enters the last documented height/weight/BMI 1104, the date 1106 the bone age exam was performed, the bone age 1108 in years, the patient's bone age 1110 in months and the estimated height a 1112 at the bone age exam and the date 1102 of the documentation of bone age. This data is stored in the patient's electronic medical record.

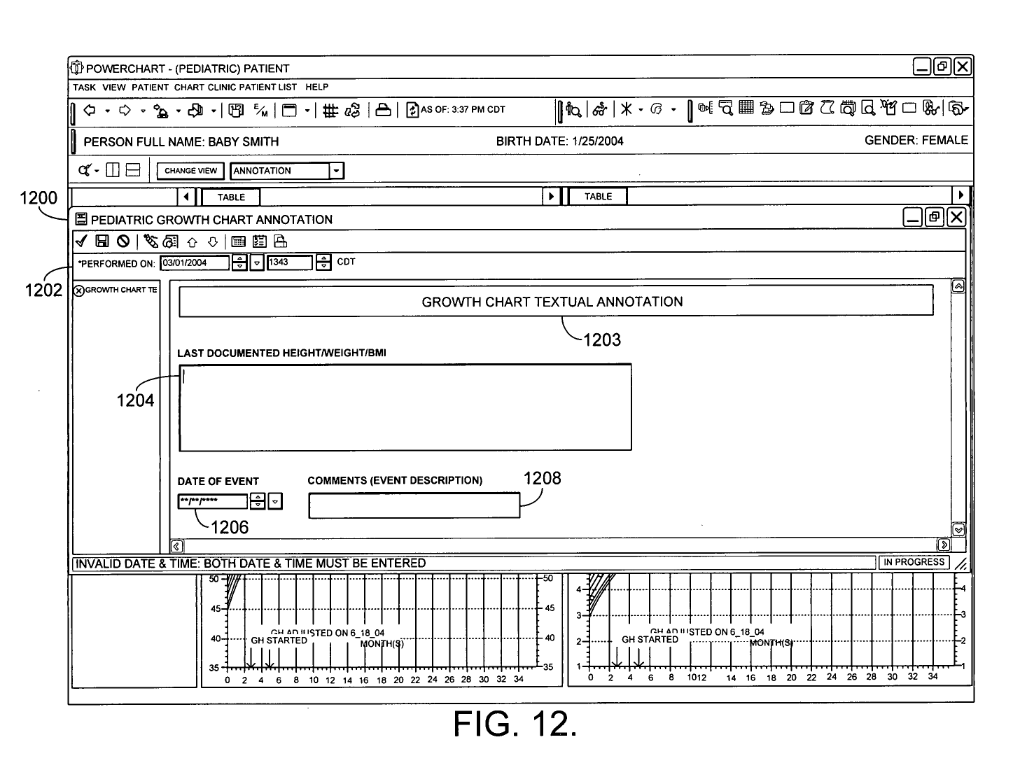

If the user selects to enter annotations 906 from FIG. 9, a data documentation form 1200, such as the exemplary documentation form shown in FIG. 12, is opened. A user can enter a growth chart textual annotation 1203 from the documentation form 1200. Data that may be displayed while documenting an annotation includes the last documented height/weight/BMI 1204 for the patient. Data that may be entered for the annotation includes the date 1206 of the event being annotated and comments 1208 regarding the event. The event annotations are stored in the patient's electronic medical record.

Referring again to FIG. 5, at step 508, the patient growth data entered into the data documentation form is received, and at step 510, is stored in the patient's EMR which may be later accessed to be displayed on an appropriate pediatric growth chart.

Referring next to FIG. 14, an exemplary interactive display of a growth chart and table of patient growth data is shown. The interactive display 1400 includes a growth chart image display area 1404, and a growth measurement table display area 1406 configured to display a growth measurement table for the patient and a navigation bar 1402. The growth chart image display area 1404 includes an appropriate growth chart generated and percentiles plotted for the patient. The growth chart also includes data points plotted for patient measurements taken at a specific age. In this example, for patient Baby Jones, a CDC length-for-age growth chart for girls 0-36 months is displayed in the growth chart image display area 1404. Patient measurements when the patient was six months and two weeks, eleven months and three weeks, fifteen months and fifteen months and three weeks are plotted on the growth chart.

The growth measurement table display area includes a tabular display of growth data for the patient. The growth data includes the date the measurement was taken, the age of the patient when the measurement was taken, the value of the measurement, the percentile of the measurement in relation to the growth chart and the z-score/standard deviation. In this example, the growth data for patient Baby Jones includes four measurements when the patient was six months and two weeks, eleven months and three weeks, fifteen months and fifteen months and three weeks are included in the exemplary growth measurement table display area 1406.

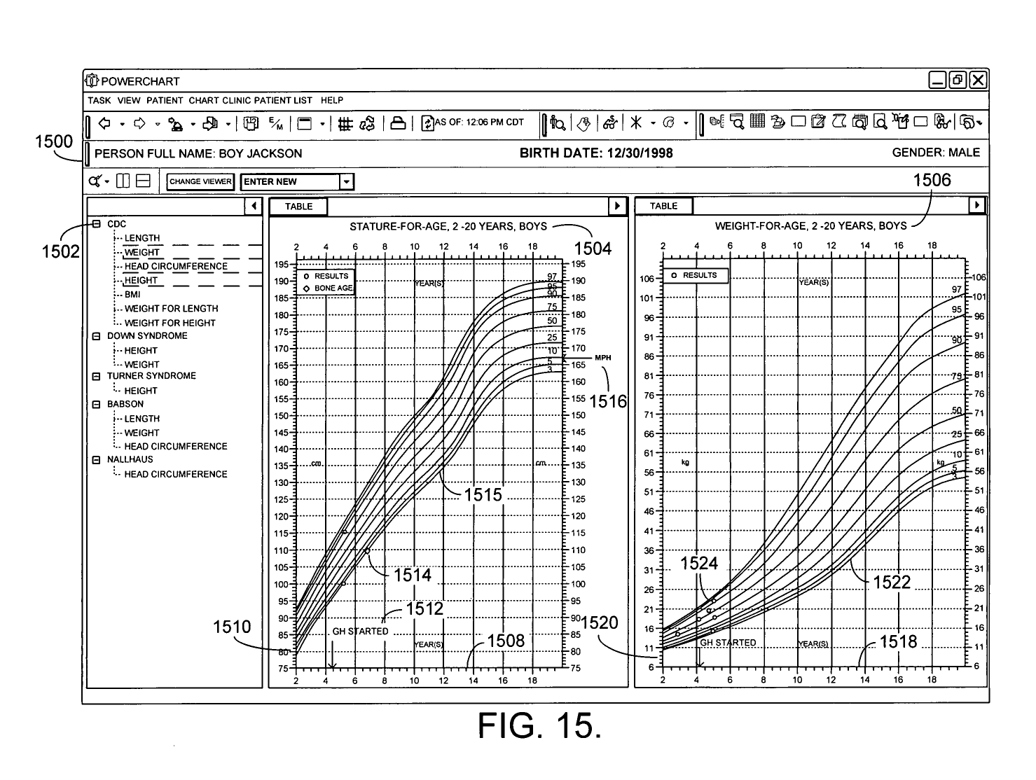

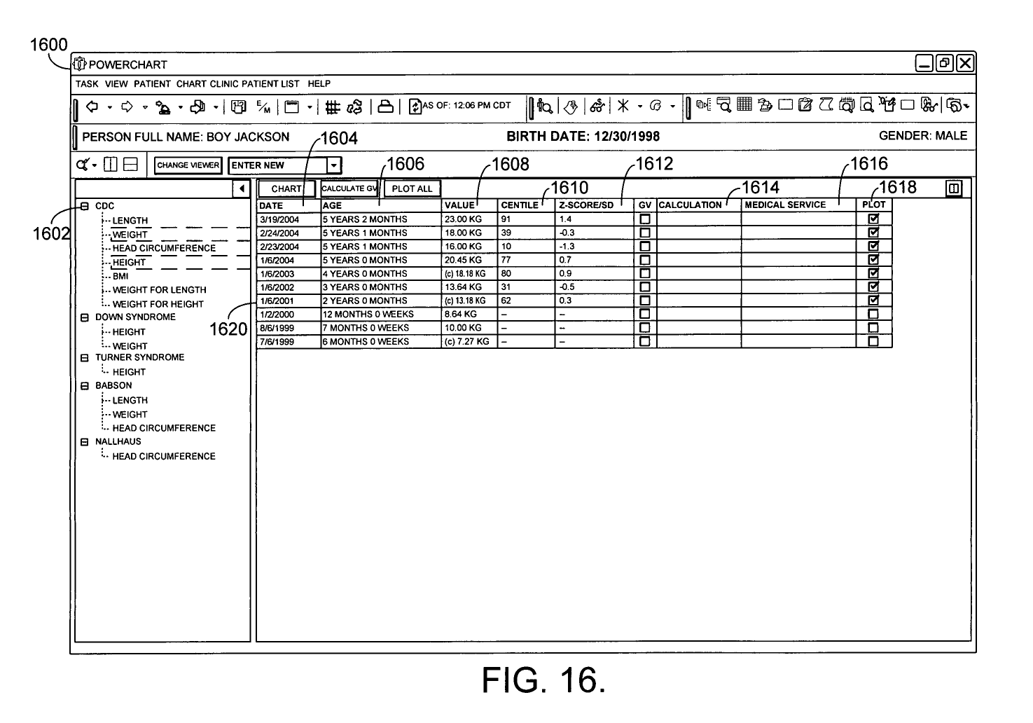

With reference to FIG. 15, an exemplary interactive side-by-side user interface 1500 of a length for age growth chart and weight for age growth chart is shown. The interactive user interface 1500 includes a first growth chart image display area 1504 configured to display a first growth chart for a patient, and a second growth chart image display area 1506 configured to display a second growth chart for a patient, the second growth chart is a different growth chart from the first growth chart displayed in image display area 1504. The exemplary user interface 1500 also includes a navigation bar 1502.

In the exemplary user interface, the first growth chart image display 1504 is configured to display the CDC's stature-for-age growth chart for boys 2-20 years old. Percentile curves 1515 are plotted on the growth chart which has a horizontal axis 1508 for the age of the patient (in years) and a vertical axis 1510 for the patient's stature measurements (in centimeters). Patient Boy Jackson's measurements 1514 are plotted on the growth chart. Event annotations 1512 and mid-parental height 1516 are also included on the stature-for-age growth chart.

The second growth chart image display is configured to display the CDC's weight-for-age growth chart for boys 2-20 years of age. Percentile curves 1522 are plotted on the growth chart which has a horizontal axis 1518 for the age of the patient (in years) and a vertical axis 1520 for the patient's weight measurements (in kilograms). Patient Boy Jackson's measurements 1524 are plotted on the growth chart. Event annotations are also included on the weight-for-age growth chart.

Referring next to FIG. 16, an interactive table display are 1600 of patient growth data according to age to be plotted on a growth chart is shown. The growth measurement table display area 1600 includes a tabular display 1620 of growth data for the patient and a navigation bar 1602. The growth data includes the date the measurement was taken 1604, the age of the patient 1606 when the measurement was taken, the value 1608 of the measurement, the percentile 1610 of the measurement in relation to the growth chart, the z-score/standard deviation 1612, calculations 1614, medical service 161 taking the measurement and whether the growth data measurement should be plotted 1618.

In another embodiment, the present invention relates to a system for displaying patient growth data on a computerized growth chart. The system comprises a first accessing component for accessing a database including growth chart data for a computerized growth chart appropriate for a patient and a utilizing component for utilizing the growth chart data to display the computerized growth chart. The system comprises a second accessing component for accessing the patient's electronic record for patient growth data and a displaying component for displaying patient growth data on the computerized growth chart.

In yet another embodiment, the present invention relates to a system for displaying patient growth data on one or more computerized growth charts. The system comprises a first accessing component for accessing a database including growth chart data for a computerized growth chart appropriate for a patient and utilizing component for utilizing the growth chart data to display at least one computerized growth chart. The system further comprises a second accessing component for accessing the patient's electronic record for patient growth data and a receiving component for receiving a selection of patient growth data to display. A displaying component displays the requested patient growth data on the at least one computerized growth chart.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

It will be understood that certain features and sub-combinations of utility may be employed without reference to features and sub-combinations and are contemplated within the scope of the claims. Furthermore, the steps performed need not be performed in the order described.

The invention claimed is:

1. A method for displaying patient growth data on a computerized growth chart, the method comprising:
accessing a database including growth chart data for a computerized growth chart appropriate for a patient;
utilizing the growth chart data to display the computerized growth chart;
accessing the patient's electronic record for patient growth data; and
displaying patient growth data on the computerized growth chart.

2. The method of claim 1, wherein the growth chart data comprises one or more of growth chart definitions, reference curve data and statistical information.

3. The method of claim 1, wherein the patient growth data comprises one or more of patient measurements, event annotations and combinations thereof.

4. The method of claim 3, wherein the patient measurements comprise one or more of the patient's length, height, weight head circumference, bone age and combinations thereof on a particular date.

5. The method of claim 3, wherein the event annotations comprise documented events for the patient.

6. The method of claim 1, wherein the computerized growth chart is a growth chart for one of height, weight, length, head circumference and bone age.

7. The method of claim 6, wherein the computerized growth chart is appropriate for the patient based on the patient's gender and age.

8. The method of claim 6, wherein the computerized growth chart is appropriate for the patient based on patient diagnosis.

9. The method of claim 4, further comprising:
calculating a percentile for one or more of the patient measurements for the computerized growth chart.

10. The method of claim 1, further comprising:
calculating a z-score for one or more of the patient measurements for the computerized growth chart.

11. The method of claim 1, further comprising:
calculating the growth velocity between two or more of the patient measurements for the computerized growth chart.

12. The method of claim 1, further comprising:
receiving mid-parental height for the patient.

13. The method of claim 12, further comprising:
utilizing data accessed from an electronic medical record for one or more of the patient's parents to determine mid-parental height.

14. The method of claim 13, further comprising:
displaying the mid-parental height on the computerized growth chart for the patient.

15. The method of claim 1, wherein the computerized growth chart appropriate for the patient is one or more of a Center for Disease Control growth chart for length, weight, head circumference, height, body mass index, weight for length, and weight for height, a Down Syndrome growth chart for height and weight, a Turner Syndrome growth chart for height, a Babson growth chart for length, weight, head circumference, and a Nallhaus growth chart for head circumference.

16. A computer-readable medium comprising the method of claim 1.

17. A method for displaying patient growth data on one or more computerized growth charts, the method comprising:
accessing a database including growth chart data for a computerized growth chart appropriate for a patient;
utilizing the growth chart data to display at least one computerized growth chart;
accessing the patient's electronic record for patient growth data;
receiving a selection of patient growth data to display; and
displaying the requested patient growth data on the at least one computerized growth chart.

18. The method of claim 17, further comprising:
receiving a selection of one or more displays of the growth chart data.

19. The method of claim 18, wherein the one or more displays of the growth chart data selected is a display of a first growth chart and a second growth chart for the patient, wherein the second growth chart is different from the first growth chart.

20. The method of claim 18, wherein the one or more displays,of the growth chart data is a display of a first growth chart for the patient and a growth measurement table for the patient.

21. The method of claim 17, wherein the growth chart data comprises one or more of growth chart definitions, reference curve data and statistical information.

22. The method of claim 17, wherein the requested patient growth data comprises one or more of patient measurements, event annotations, mid-parental height, z-score, percentile, growth velocity and combinations thereof.

23. The method of claim 22, wherein the patient measurements comprise one or more of the patient's length, height, weight, head circumference, bone and combinations thereof on a particular date.

24. The method of claim 17, wherein the at least one computerized growth chart is a growth chart for one of height, weight, length, head circumference and bone age.

25. The method of claim 24, wherein the at least one computerized growth chart is appropriate for the patient based on the patient's gender and age.

26. The method of claim 24, wherein the at least one computerized growth chart is appropriate for the patient based on patient diagnosis.

27. The method of claim 17, wherein the at least one computerized growth chart appropriate for the patient is one or more of a Center for Disease Control growth chart for length, weight, head circumference, height, body mass index, weight for length, or weight for height, a Down Syndrome growth chart for height or weight, a Turner Syndrome growth chart for height, a Babson growth chart for length, weight, or head circumference, and a Nallhaus growth chart for head circumference.

28. A computer readable medium comprising the method of claim 17.

29. A user interface embodied on at least one computer readable medium, the user interface for representing data to a user, comprising:
a growth chart image display area configured to display at least one growth chart for a patient; and
a growth measurement table display area configured to display a growth measurement table for the patient.

30. A user interface embodied on at least one computer readable medium, the user interface for representing data to a user, comprising:
a first growth chart display area configured to display a first growth chart for a patient; and
a second growth chart display area configured to display a second growth chart for a patient, the second growth chart being different from the first growth chart.
